(19) United States
(12) Patent Application Publication
(10) Pub. No.: US 2026/0132855 A1
(43) Pub. Date: May 14, 2026

(54) VALVE

(71) Applicant: TI Automotive Technology Center GmbH, Rastatt (DE)

(72) Inventor: Artem Tuzin, Stutensee (DE)

(21) Appl. No.: 19/381,578

(22) Filed: Nov. 6, 2025

(30) Foreign Application Priority Data
Nov. 8, 2024 (DE) 202024106429.1

(51) Int. Cl. F16K 5/04; F16K 27/06

(52) U.S. Cl. CPC F16K 5/0471; F16K 5/0485; F16K 27/065

(57) ABSTRACT

A valve, comprising a valve housing with a valve chamber, wherein the valve chamber has a chamber wall into which at least one fluid channel opens, wherein a valve core is supported in the valve chamber, wherein the valve core is provided with a channel structure which interacts with the fluid channel, wherein a seal is associated with the fluid channel, wherein the seal is arranged on the chamber wall, wherein the seal has a flat design and comprises at least two layers.

### RELATED APPLICATIONS

The present disclosure claims priority to and the benefit of German Application No. 202024106429.1, filed on November 8, 2024 the entire contents of each of which are incorporated herein by reference.

### FIELD

The present disclosure relates to a valve comprising a valve housing with a valve chamber, wherein the valve chamber has a chamber wall into which at least one fluid channel opens, wherein a valve core is supported in the valve chamber, wherein the valve core is provided with a channel structure which interacts with the fluid channel, wherein a seal is associated with the fluid channel.

### BACKGROUND

A valve in this field is known from WO 2017/095994 A1. The valve described there is formed as a rotary valve and is used in cooling circuits to control the coolant flow. A cooling fluid can flow in and out of the valve through the fluid openings that open into the valve housing. The channel structure which is introduced into the valve core controls the coolant flow, wherein, depending on the design and number of fluid channels, different cooling circuits can be controlled, the volume flow of the coolant can be regulated and/or the flow direction of the coolant can be adjusted.

With a rotary valve, the coolant flow is adjusted by rotating the valve core, wherein the corresponding actuator for rotating the valve core is formed in a simple manner and is easy to control. Accordingly, rotary valves and the associated actuators are inexpensive to manufacture and require little installation space.

Accordingly, rotary valves are particularly advantageous for use in temperature control circuits in the field of electromobility. The components of electric vehicles whose temperature needs to be controlled are, in particular, electrical energy storage devices, and also the power electronics or plug connections of fast-charging devices. The temperature control medium flowing through the temperature control circuit can be heated in a heating device or cooled in a cooling device, depending on requirements. The temperature control medium is controlled via one or more rotary valves.

To prevent internal leakage, a sealing body is arranged in the area of the transition between the fluid channel and the valve core. We have discovered that, depending on the design, the sealing body can cause high frictional forces, which as a negative effect on wear and the required actuating force of the actuator. On the other hand, internal leaks between the valve housing and valve core should be avoided as far as possible.

### BRIEF SUMMARY

The present disclosure provides a valve that can be manufactured at low cost and has a long service life.

The valve according to the present disclosure comprises a valve housing with a valve chamber, wherein the valve chamber has a chamber wall into which at least one fluid channel opens, wherein a valve core is supported in the valve chamber, wherein the valve core is provided with a channel structure which interacts with the fluid channel, wherein a seal is associated with the fluid channel, wherein the seal is arranged on the chamber wall, wherein the seal is formed flat and comprises at least two layers.

The seal according to the present disclosure is particularly easy and inexpensive to manufacture due to its flat design, and positioning the seal during assembly is also particularly simple. The two-layer design of the seal

makes it possible to provide a first layer that is friction-optimized and a second layer that has particularly advantageous resilient properties. This design having a flat configuration and/or two-layer configuration enables a high sealing effect with low frictional force. This reduces the torque required to move the valve core and makes it possible to use more cost-effective actuators.

The seal can be formed rectangular and have an opening that corresponds to the fluid channel. In this design, the seal is in the form of a flat seal and is particularly easy to position on the chamber wall of the valve chamber.

The seal can have a sealing bond on at least one side of the edge delimiting the opening. The sealing bead is preferably formed on the side facing the valve core. According to a further embodiment, the sealing bead is formed on both sides and extends in the direction of the valve housing and the valve core. The sealing bead constitutes a material reinforcement, which has a beneficial effect on the mechanical stability of the seal. Furthermore, the sealing bead enables a defined contact of the valve core and thus a particularly targeted sealing effect with low frictional forces.

In an advantageous further development, sealing beads are arranged on both sides of the edge delimiting the opening. In such a case, one sealing bead extends in the direction of the chamber wall and one sealing bead in the direction of the valve core. This improves the sealing effect of the arrangement.

The sealing bead can have an arc-shaped contour. The arc-shaped contour results in a gradual increase in the thickness of the sealing bead and thus a wider contact surface of the seal on the mating body to be sealed, e.g. the valve core. In contrast, a seal design in the form of a sealing lip or a sealing rib often has a linear contact surface, but this is associated with a very high

contact pressure that promotes wear. If, on the other hand, the sealing bead is arc-shaped, this results in a widened contact surface forming the sealing surface with a flat distribution of the contact pressure. This reduces the risk of wear and prevents permanent deformation of the sealing geometry. This is particularly advantageous if the layer of the seal facing the valve core is formed as a foil and therefore only has a very low material thickness. By reducing the contact pressure, premature wear of this layer can be avoided. Alternatively, the sealing bead can also be formed rectangular. This further increases the contact surface compared to the arc-shaped design of the sealing bead. However, the reduction in contact pressure can simultaneously also lead to minor leaks.

The seal can have supporting beads on the edges pointing in the circumferential direction. The supporting beads improve the dimensional stability and mechanical stability of the seal. The supporting beads also make it easier to fit the seal. Preferably, the supporting beads have an arc-shaped contour. The contours of the sealing bead and supporting beads can be formed in a comparable way. If the supporting beads are also provided with an arc-shaped contour, wear is also reduced in these areas while the sealing force remains high. Alternatively, the supporting beads can also be formed rectangular. The supporting beads can protrude in the direction of the chamber wall or the valve core. Preferably, the supporting beads are formed in such a way that they extend in the direction of the chamber wall and the valve core.

Supporting ribs can be associated with the fluid channels, which supporting ribs extend in an axial direction and project radially inwards, wherein the seal is arranged between two supporting ribs. On the one hand, the supporting ribs form positioning aids that enable the seal to be installed quickly and easily. On the other hand, the seal can be supported on the supporting ribs when the valve core is adjusted and a mechanical force acting in the circumferential direction of the chamber wall is introduced into the seal as a result.

The supporting beads can come into contact with the supporting ribs. As a result, the seal is positioned particularly securely between the supporting ribs, and the arrangement of the valve chamber and seal is particularly stable.

The valve can be formed as a rotary valve with a cylindrical valve chamber. In this design, the valve core is adjusted by rotation, and the fluid channels extend outwards in a radial direction from the chamber wall. The seal is located inside the valve housing on the chamber wall, and the valve core rotates along the seals. The valve housing and the valve core can be formed of plastic and can therefore be manufactured cost-effectively.

The valve can be formed as a proportional valve. In this design, the valve core can also assume intermediate positions in which fluid channels are partially open or partially closed. This design places particularly high stress on the seal, as the boundary walls of the channel structures of the valve core only cover partial areas of the seal and high contact pressure forces can occur on the seal in the edge areas of the channel structures of the valve core. However, the design of the seal according to the present disclosure means that it has a long service life even when the valve is designed as a proportional valve. Alternatively, the valve can also be formed as a switching valve.

A first layer of the seal can be formed of an elastomeric material, and a second layer of the seal can be formed of a material with low friction, i.e. lower than the first layer, e.g. polytetrafluoroethylene (PTFE), wherein the second layer faces the valve core. Accordingly, the first layer forms an elastically resilient layer, and the second layer has a particularly low coefficient of friction. The combination of both properties results in a seal with a high sealing effect, wherein the frictional forces are low so that the valve core can be moved, in particular rotated, with low resistance in relation to the valve housing.

The first layer can be formed of ethylene-propylene-diene monomer (EPDM). EPDM is an elastomeric material that is ideally suited for use with aqueous media and is also resistant to high media temperatures.

The contours of the sealing bead and supporting beads can have a radius of between 1mm and 3mm. This results in a gradual increase in the thickness of the sealing bead and supporting beads and, as a result, a flat contact between the seal and the chamber wall and valve core.

The contours of the sealing bead and supporting beads can form a flat contact region in the sections facing the valve core and the chamber wall. Compared to a linear contact region, the contact surface is enlarged, and the surface pressure is reduced once again. This is associated with advantages in terms of service life and a reduction in the risk of permanent deformation of the seal.

The valve housing can be provided with an installation opening at the end face. The installation opening can be connected to the channel structure in a flow-conducting manner. A valve designed in this way is particularly suitable for integration into a piping arrangement, especially a piping arrangement manufactured using the blow molding process.

The media flowing through the valve can enter and exit the valve both via the fluid channels and via the installation opening. The valve core is only supported on the end face opposite the installation opening. The valve core is only supported on one side. Accordingly, the valve core is supported on one side even when the installation opening is closed. This makes the valve particularly easy to install and the valve housing is simple and inexpensive to manufacture.

### BRIEF DESCRIPTION OF THE DRAWINGS

Some embodiments of the valve according to the present disclosure are explained in more detail below with reference to the figures. The figures show, in each case schematically:

FIG. 1 a valve housing of a valve with seals in three-dimensional depiction;

FIG. 2 a section of the valve with valve housing, seal and valve core in sectional view;

FIG. 3 a seal in front and rear view;

FIG. 4 the valve housing in three-dimensional depiction;

FIG. 5 a rotary valve in sectional view.

### DETAILED DESCRIPTION

The figures show a valve 1 in the form of a rotary valve, which is arranged in a temperature control unit of a vehicle and directs coolant flows there.

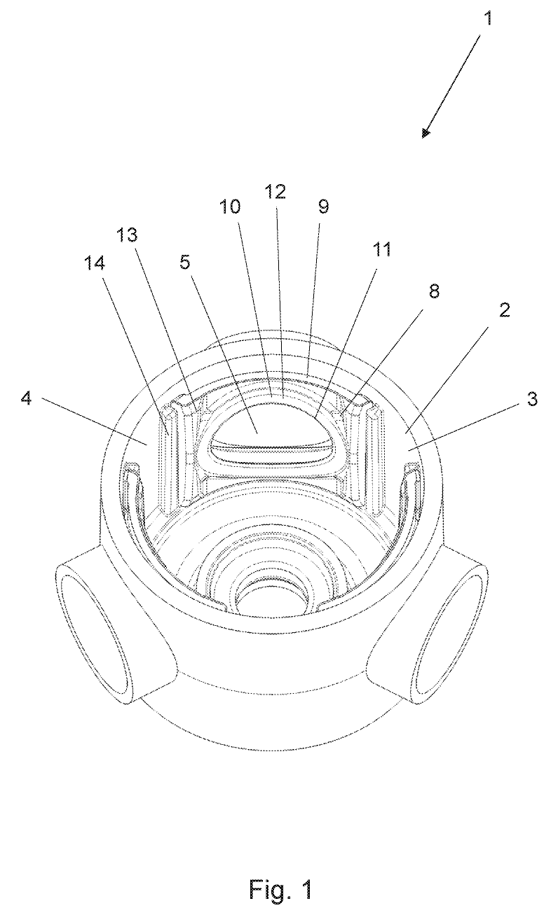

FIG. 1 shows the valve 1 in a three-dimensional depiction. The valve 1 comprises a valve housing 2 with a cylindrical valve chamber 3, wherein the valve chamber 3 has a chamber wall 4 into which several fluid channels 5 open.

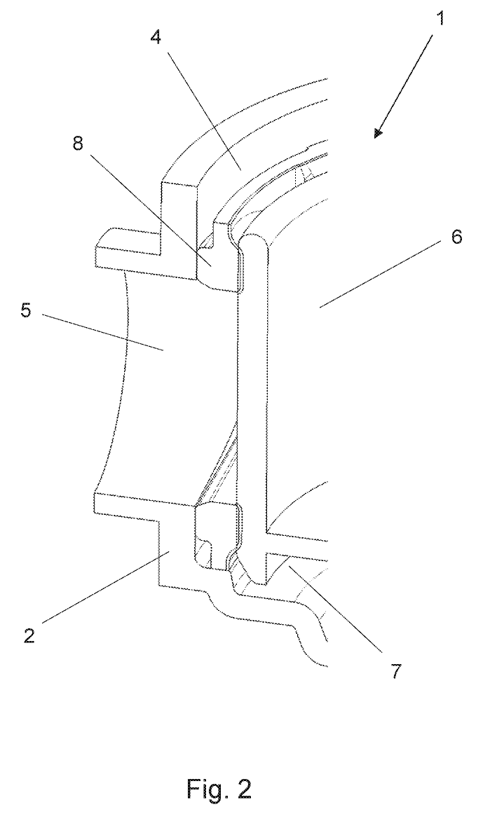

FIG. 2 shows that a valve core 6 is supported in the valve chamber 3, wherein the valve core 6 is provided with a channel structure 7, which interacts with the fluid channels 5. The valve housing 2 and the valve core 6 are made of plastic and manufactured by injection molding. The valve core 6 is adjusted via an electromagnetically driven actuator. The valve 1 shown here is formed as a proportional valve. For this purpose, the valve core 6 is formed to be infinitely adjustable by the actuator. The valve core 6 can assume intermediate positions relative to the fluid channels 5, in which only partial volume flows can flow into or out of the fluid channels 5.

A seal 8 is associated with each of the fluid channels 5, wherein the seal 8 is arranged on the chamber wall 4 of the valve housing 2. The seals 8 are formed flat and comprise two layers 9, 10. The first layer 9 is formed of an elastomeric material, in this case EPDM, and a second layer 10 is formed of a material with a low coefficient of friction, in this case PTFE. The first layer 9 faces the valve housing 2 and the second layer 10 faces the valve core 6.

The seals 8 are formed rectangular and have an opening 11 which corresponds to the fluid channels 5. The seals 8 each have sealing beads 12 on the edge delimiting the opening 11, wherein one sealing bead 12 faces the valve housing 2 and one sealing bead 12 faces the valve core 6, wherein the sealing bead 12 has an arc-shaped contour on the side facing the valve core 6. On the side facing the valve housing 2, the sealing bead 12 is flattened and therefore abuts flat against the valve housing 2.

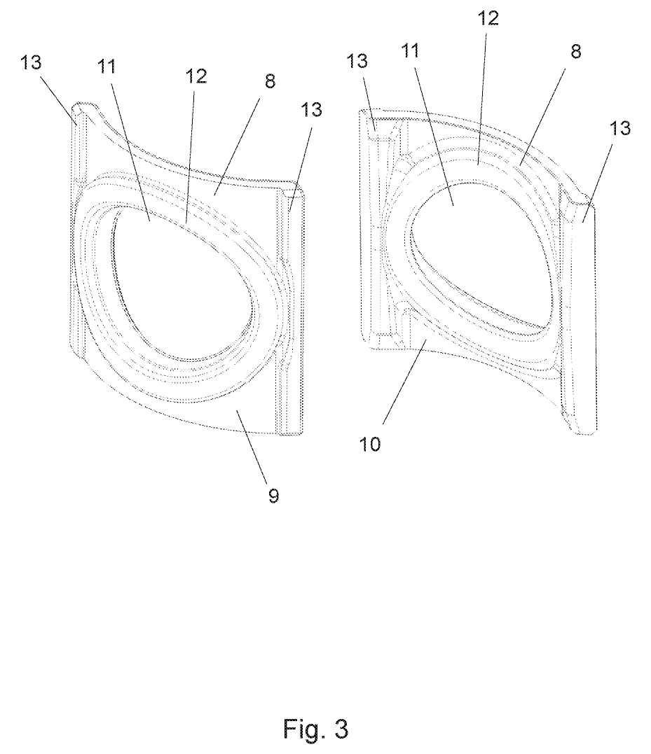

A seal 8 is shown in detail in FIG. 3, wherein the left-hand representation shows the seal 8 on the side facing the valve housing 2 with the first layer 9 and the right-hand representation shows the seal 8 on the side facing the valve core 6 with the second layer 10.

The seals 8 each have supporting beads 13 on the edges pointing in the circumferential direction, wherein the supporting beads 13 come into contact with the supporting ribs 14. The supporting ribs 14 prevent the seals 8 from moving in the circumferential direction. Just like the sealing beads 12, the supporting beads 13 have an arc-shaped contour. The supporting beads 13 extend both in the direction of the chamber wall 4 and in the direction of the valve core 6.

The contours of the sealing beads 12 and supporting beads 13 have a radius of 2 mm. The contours of the sealing beads 12 and the supporting beads 13 have a flat contact region 19, 19' in the sections facing the valve core 6 and the chamber wall 4.

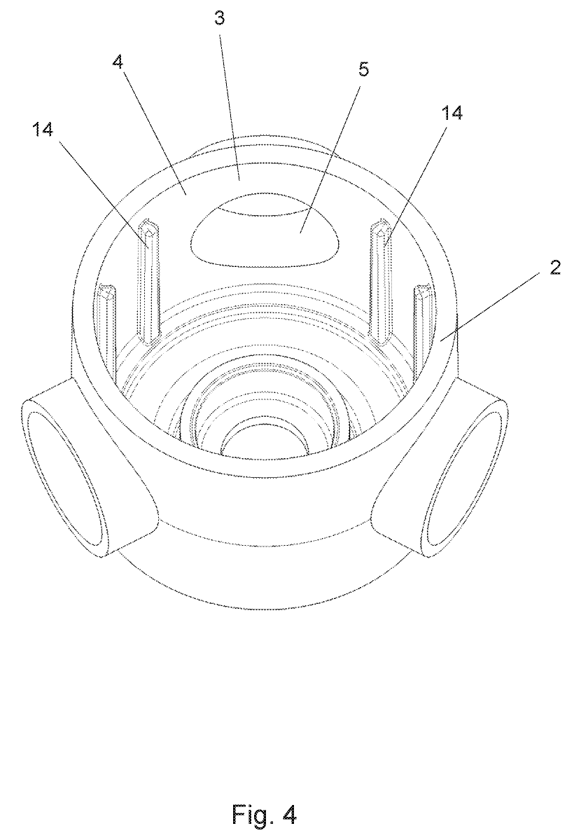

FIG. 4 shows the valve housing 2 in detail in a three-dimensional depiction. Supporting ribs 14 are associated with the fluid channels 5, which supporting ribs extend in an axial direction and protrude radially inwards. Two supporting ribs 14 are provided for each fluid channel 5, wherein one supporting rib 14 is provided on each side of the fluid channel when viewed in the circumferential direction. The seals 8 are each arranged between two supporting ribs 14.

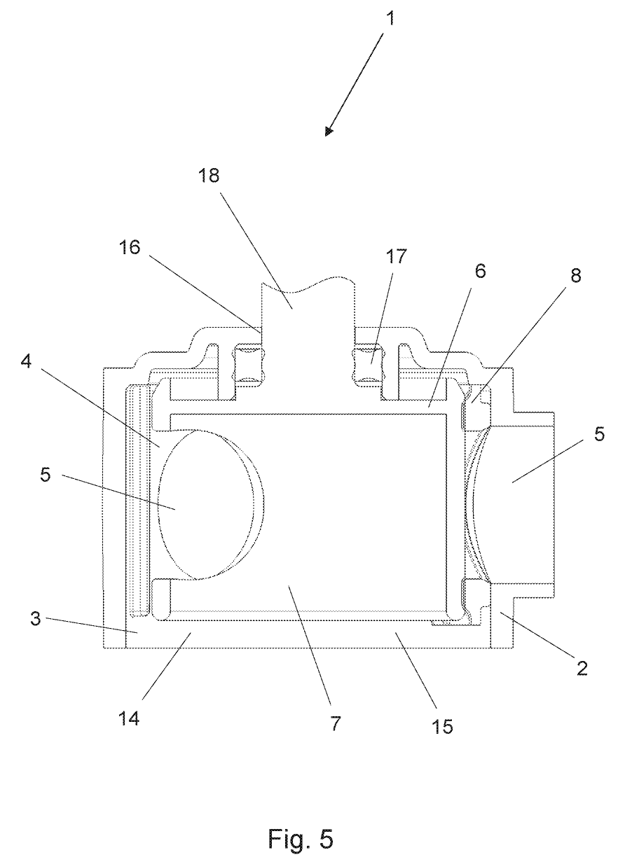

FIG. 5 shows the valve 1 according toFIG. 1 with installed valve core 6 in section

The valve housing 2 has an installation opening 15 at the axial lower end, which installation opening extends over the end face of the axial end. The valve core 6 can be inserted into the valve housing 2 for installation through the installation opening 15. The valve core 6 has a drive shaft 18, which projects through a feedthrough opening 16 introduced in the valve housing 2 on the side opposite the installation opening 15. The drive shaft 18 is configured to be operatively connected to an actuator in order to rotate the valve core 6.

The advantage of this design is that assembly is simplified and that the valve housing 2 can be formed in one piece. The valve core 6 is locked in the region of the drive shaft 15 on the outside of the valve housing 2, for example

by means of a securing ring, and is therefore held in the valve housing 2 in a loss-proof manner.

The valve core 6 is only supported on the end face associated with the drive shaft 18, so that the valve core 6 is only supported on one side. In this exemplary embodiment, the supporting is provided by a sealing ring 17, here designed as an X-ring, which also acts as a seal for the gap between the valve housing 2 and the drive shaft 18. The valve core 6 is guided axially in the valve housing 2 via the sealing ring 17 and the valve core 6 is guided radially in the valve housing 2 via the seals 8.

The installation opening 15 is connected to the channel structure 7 of the valve core 6 in a flow-conducting manner. This allows medium to flow in and out of the valve 1 via the fluid channels 5 and the installation opening 15.

1. A valve, comprising:
a valve housing with a valve chamber, wherein the valve chamber has a chamber wall into which at least one fluid channel opens;
a valve core supported in the valve chamber, wherein the valve core is provided with a channel structure which interacts with the fluid channel; and
a seal is associated with the fluid channel, wherein the seal is arranged on the chamber wall, wherein the seal has a flat configuration and comprises at least two layers.

2. The valve according to claim 1, wherein the seal is formed rectangular and has an opening which corresponds to the fluid channel.

3. The valve according to claim 2, wherein the seal has a sealing bead on at least one side of the edge delimiting the opening.

4. The valve according to claim 2, wherein the seal has a sealing bead on both sides of the edge delimiting the opening.

5. The valve according to claim 3, wherein the sealing bead has an arc-shaped contour.

6. The valve according to claim 3, wherein the sealing bead forms a flat contact region.

7. The valve according to claim 1, wherein the seal has supporting beads on its edges pointing in the circumferential direction.

8. The valve according to claim 7, wherein the supporting beads have an arc-shaped contour.

9. The valve according to claim 7, wherein the supporting bead forms a flat contact region.

10. The valve according to claim 1, wherein the fluid channels are associated with supporting ribs which extend in the axial direction and project radially inwards, wherein the seal is arranged between two supporting ribs.

11. The valve according to claim 10, wherein the supporting beads come into contact with the supporting ribs.

12. The valve according to claim 1, wherein the valve is formed as a rotary valve with a cylindrical valve chamber.

13. The valve according to claim 1, wherein the valve is formed as a proportional valve or as a switching valve.

14. The valve according to claim 1, wherein a first layer is formed from an elastomeric material and a second layer is formed from a material with a low coefficient of friction, wherein the second layer faces the valve core.

15. The valve according to claim 14, wherein the second layer is formed of PTFE.

16. The valve according to claim 14, wherein the first layer is formed of EPDM.

17. The valve according to claim 4, wherein the contours of the sealing bead have a plateau in the sections facing the valve core and the chamber wall and are flattened.

18. The valve according to claim 1, wherein the valve housing is provided with an installation opening on the end face.

19. The valve according to claim 18, wherein the installation opening interacts with the channel structure of the valve core in a flow-conducting manner.

20. The valve according to claim 18, wherein the valve core is supported on one side on an end face of a feedthrough opening, the feedthrough opening being opposite the installation opening.
